(19) United States
(12) Patent Application Publication
(10) Pub. No.: US 2013/0257791 A1
(43) Pub. Date: Oct. 3, 2013

(54) CAPACITIVE TOUCH SCREEN AND MANUFACTURING METHOD THEREOF

(71) Applicants: Lianghua Mo, Shenzhen (CN); Hua Li, Shenzhen (CN)

(72) Inventors: Lianghua Mo, Shenzhen (CN); Hua Li, Shenzhen (CN)

(21) Appl. No.: 13/586,238

(22) Filed: Aug. 15, 2012

(30) Foreign Application Priority Data
Mar. 30, 2012 (CN) 201210089872.0

(51) Int. Cl. G06F 3/044; B32B 37/02

(52) U.S. Cl. 345/174; 156/278

(57) ABSTRACT

The invention relates to a capacitive touch screen and a manufacturing method thereof, wherein a touch chip does not need package test and only needs a chip wafer. Therefore, compared with the traditional touch chip for a touch screen module, the package cost and the package test cost of the chip are reduced. Meanwhile, due to small area of the chip, the amount of space is small compared with the traditional touch chip with a package outline. The invention has the advantages that: the overall material cost of the capacitive touch screen can be effectively reduced; the capacitive touch screen is easy to produce; the requirements on the manufacturing processes of the capacitive touch screen are reduced; and the product yield is improved.

### FIELD OF THE INVENTION

The invention relates to a capacitive touch screen and a manufacturing method thereof, in particular to a capacitive touch screen and a manufacturing method thereof, wherein a transparent conductive material is provided with a light shield layer.

### BACKGROUND OF THE INVENTION

Currently, capacitive touch screens have been main components for human-computer interaction in the market. Compared with the traditional resistance screen and infrared touch screen, the capacitive touch screen can provide better user experience. Therefore, the capacitive touch screen is more and more applied to mobile phones, MIDs, panel computers and other portable consumer electronics products and has been an indispensable main component. Wherein, capacitive touch screens are the most representative. The available capacitive touch screen mainly comprises a cover lens, a touch sensor and a flexible printed circuit (FPC). Moreover, a touch chip is an indispensable component in a capacitive touch control system. The actual placing positions of the touch chip at the application end in the market are approximately given below: as illustrated in FIG. 1, a touch chip D is placed on a flexible printed circuit C and forms an integrated touch screen module together with a cover lens A and a touch sensor B, which is known as COF (Chip on FPC); and as illustrated in FIG. 2, the touch chip D is placed on a system mainboard E for simplifying the production of the touch screen module, which is known as COB (Chip on Board). In the above two means, the touch screen module needs the cover lens A which can be made of materials such as glass, PET (polyethylene terephthalate) and PMMA (polymethyl methacrylate); a substrate for the touch sensor B is usually a piece of glass or a film; and the touch chip D is a chip provided with a package. No matter the touch chip D is welded on the flexible printed circuit C or a rigid printed circuit E, the touch chip D occupies large space. Moreover, the package cost is also high and the cost of the module and the complete machine is improved.

Currently, a novel touch screen implementation is mentioned in relevant information. As illustrated in FIG. 3, firstly, an inductive ITO graph of a touch screen is formed on the lower surface of the cover lens of the traditional touch screen, so that the cover lens A and the touch sensor of the traditional capacitive touch screen module are integrated into a whole, which is known as OGS (One Glass Solution). Secondly, the touch chip D is bound at a light shield area F on the lower surface of the cover lens glass A by the COG (Chip on Glass) manufacturing process, wherein the light shield area F is usually made of light shield materials such as light-tight and pigmented ink or metal. Thirdly, the ITO graph is connected with the touch chip D through a wire made of ITO or metal, wherein the wire is also arranged inside the light shield area F on the lower surface of the cover lens glass A. Although the COG solution as illustrated in FIG. 3 reduces the overall cost of the touch screen module compared with the COF solution and the COB solution, the COG solution is extremely difficult to realize. The COG manufacturing process requires the binding of a touch IC (Integrated Circuit) on the glass and has the problem of difficult alignment of the IC and the glass during the binding. Meanwhile, due to small mark on an IC wafer and a PAD at a lead-out port on the IC wafer (usually micro-size), a CCD (Charge Coupled Device) camera is generally required for precise alignment in order to realize high-precision alignment. Moreover, the solution adopts the binding of the IC at a light shield area of the cover lens and the light shield area has been coated with light shield materials which can shield light from penetrating through the glass or from reflecting, which is unfavorable for the coordinate alignment during the IC binding. Therefore, the binding of the IC on the cover lens in the solution is very difficult and the COG binding by adoption of available equipment is unfavorable.

### SUMMARY OF THE INVENTION

The invention aims to provide a capacitive touch screen and a manufacturing method thereof and overcome the technical problems in the prior art of high manufacturing cost and complex processes.

The technical proposal of the invention is that: the invention provides a capacitive touch screen, which comprises a transparent conductive material, a touch sensor for touch sensing and a touch chip, wherein a plurality of transparent conductive electrodes forming capacitances are arranged at one side of the touch sensor; the transparent conductive material is bonded at the other side of the touch sensor; the touch chip is bound on the touch sensor; and the transparent conductive material is provided with a light shield layer.

Further technical proposal of the invention is that: the transparent conductive electrodes are arranged in the middle of the touch sensor to form a touch area of the touch sensor; and the transparent conductive material is provided with the light shield layer at an edge of the touch area.

Further technical proposal of the invention is that: the capacitive touch screen also comprises a flexible printed circuit connected with the touch chip; the flexible printed circuit is bound on the touch sensor; the transparent conductive electrodes are connected with the touch chip through connecting wires; the touch chip, the flexible printed circuit and the connecting wires are all arranged outside the touch area of the touch sensor; and the transparent conductive material is provided with the light shield layer at an area corresponding to the area at which the touch chip, the flexible printed circuit and the connecting wires are arranged.

Further technical proposal of the invention is that: the touch chip is connected with the connecting wires through anisotropical conductive films.

Further technical proposal of the invention is that: the touch chip is bound on the touch sensor by the COG manufacturing process.

Further technical proposal of the invention is that: the flexible printed circuit is bound on the touch sensor through an anisotropical conductive film.

Further technical proposal of the invention is that: the touch chip, the flexible printed circuit and the connecting wires surround the circumference of the transparent conductive electrodes.

Further technical proposal of the invention is that: the light shield layer is arranged at an edge of the transparent conductive material and surrounds an area of the transparent conductive material corresponding to the touch area of the touch sensor.

Further technical proposal of the invention is that: protective layers are arranged on the transparent conductive electrodes.

Further technical proposal of the invention is that: the invention provides a method for manufacturing a capacitive touch screen, wherein the capacitive touch screen comprises a transparent conductive material, a touch sensor for touch sensing and a touch chip; a plurality of transparent conductive electrodes forming capacitances are arranged at one side of the touch sensor; and the method for manufacturing the capacitive touch screen comprises the following steps of:

formation of the electrodes and a light shield layer, wherein transparent conducting materials are coated on the touch sensor to form the transparent conductive electrodes, and the light shield layer is arranged on the transparent conductive material;

binding, wherein the touch chip is bound on the touch sensor; and

bonding, wherein the transparent conductive material is bonded at the other side of the touch sensor corresponding to one side of the touch sensor provided with the transparent conductive electrodes.

Further technical proposal of the invention is that: in the step of the formation of the electrodes and the light shield layer, protective layers are arranged on the transparent conductive electrodes.

The invention has the advantages that: the invention provides a capacitive touch screen, which comprises a transparent conductive material, a touch sensor for touch sensing and a touch chip, wherein a plurality of transparent conductive electrodes forming capacitances are arranged at one side of the touch sensor; the transparent conductive material is bonded at the other side of the touch sensor; the touch chip is bound on the touch sensor; and the transparent conductive material is provided with a light shield layer. In the capacitive touch screen and the manufacturing method thereof, the touch chip does need package test and only needs a chip wafer. Therefore, compared with the traditional touch chip for a touch screen module, the package cost and the package test cost of the chip are reduced. Meanwhile, due to small area of the chip, the amount of space is small compared with the traditional touch chip with a package outline. Therefore, the overall material cost of the capacitive touch screen can be effectively reduced; the capacitive touch screen is easy to produce; the requirements on the manufacturing processes of the capacitive touch screen are reduced; and the product yield is improved.

### BRIEF DESCRIPTION OF THE DRAWINGS

FIG. 1 is the traditional technical drawing of the capacitive touch screen at COF mode;

FIG. 2 is the traditional technical drawing of the capacitive touch screen at COB mode;

FIG. 3 is a third traditional technical drawing of the capacitive touch screen;

FIG. 4 is a structure diagram of the capacitive touch screen provided by the invention;

FIG. 5 is an exterior view of the capacitive touch screen provided by the invention; and

FIG. 6 is a flow chart illustrating the method for manufacturing the capacitive touch screen.

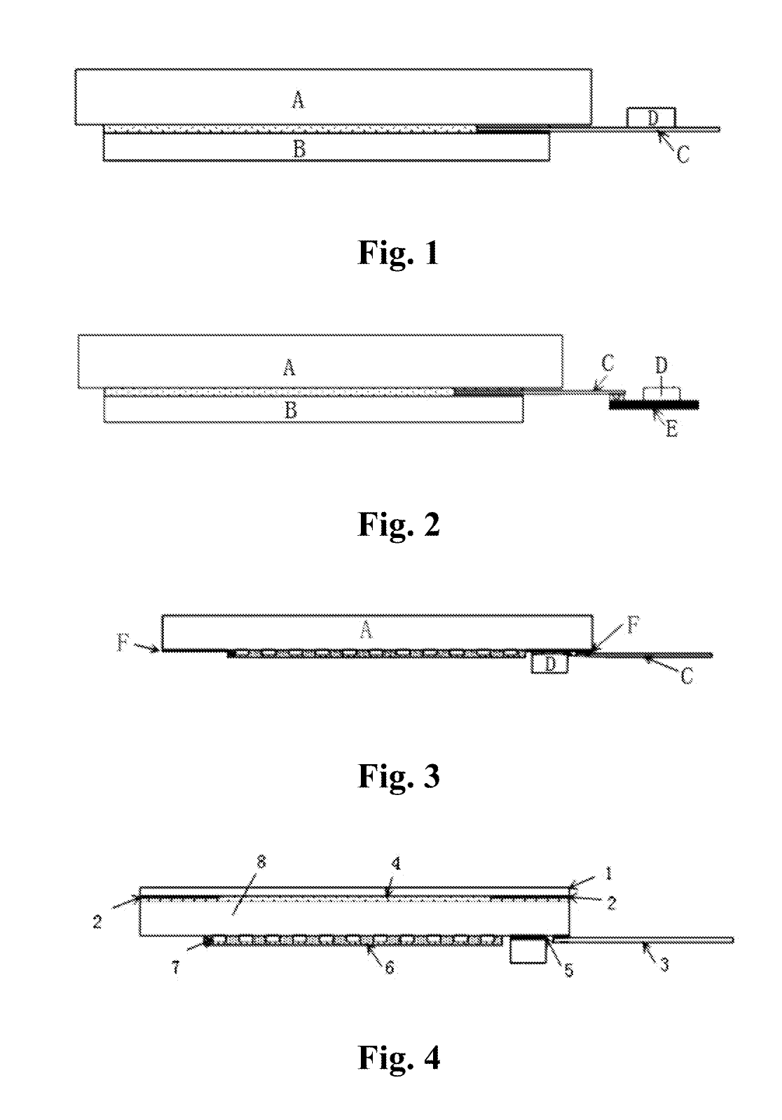

### DETAILED DESCRIPTION OF THE PREFERRED EMBODIMENTS

Further description is given to the technical proposal of the invention with the attached preferred embodiments.

As illustrated in FIG. 4, in a preferred embodiment of the invention, the invention provides a capacitive touch screen, which comprises a transparent conductive material 1, a touch sensor 8 for touch sensing and a touch chip 5, wherein a plurality of transparent conductive electrodes 7 forming capacitances are arranged at one side of the touch sensor 8; the transparent conductive material 1 is bonded at the other side of the touch sensor 8; the touch chip 5 is bound on the touch sensor 8; and the transparent conductive material 1 is provided with a light shield layer 2.

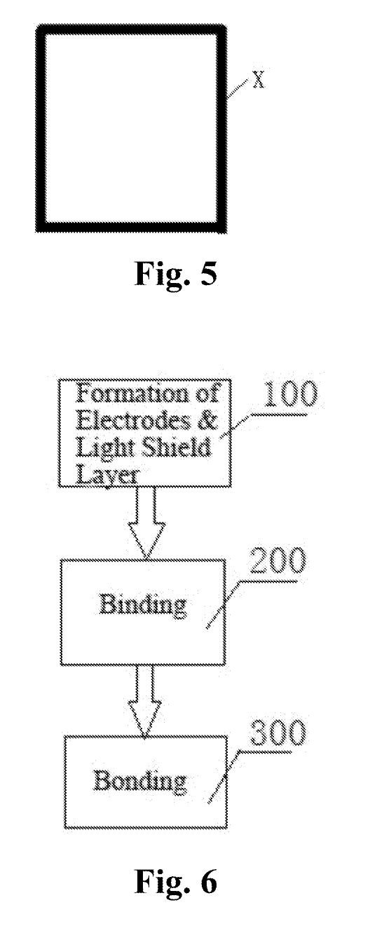

As illustrated in FIGS. 4 and 5, in a preferred embodiment of the invention, the capacitive touch screen provided by the invention comprises a transparent conductive material 1, a touch sensor 8 for touch sensing, a touch chip 5 and a flexible printed circuit 3 connected with the touch chip 5, wherein a plurality of transparent conductive electrodes 7 forming capacitances are arranged at one side of the touch sensor 8; the transparent conductive material 1 is bonded at the other side of the touch sensor 8; the transparent conductive electrodes 7 are arranged in the middle of the touch sensor 8 to form a touch area of the touch sensor 8; the touch chip 5 and the flexible printed circuit 3 are bound on the touch sensor 8 and arranged at the side of the touch sensor 8 provided with the transparent conductive electrodes 7; the transparent conductive electrodes 7 are connected with a touch chip 5 through connecting wires; the touch chip 5, the flexible printed circuit 3 and the connecting wires are all arranged outside the touch area of the touch sensor 8; and the transparent conductive material 1 is provided with a light shield layer 2 at an area corresponding to the area at which the touch chip 5, the flexible printed circuit 3 and the connecting wires are arranged.

As illustrated in FIG. 4, the specific implementation process of the invention is as follows: in the capacitive touch screen module, the transparent conductive material 1 is a transparent film such as a high-temperature resistant polyester film and a PC (polycarbonate) film; the light shield layer 2 is attached to the lower surface of the transparent conductive material 1 and made of various pigmented inks or light shield materials capable of being effectively combined with the transparent conductive material 1 and can effectively shield the connecting wires, the touch chip 5 and the flexible printed circuit 3 under the touch sensor 8; a substrate for the touch sensor 8 is usually made of rigid transparent materials such as glass; transparent conducting materials, for example, ITO conductive glass, are coated on the touch area on the substrate for the touch sensor 8 to form the conductive electrodes; capacitances are formed between the conductive electrodes; the connecting wires are arranged outside the touch area of the substrate for the touch sensor 8; one ends of the connecting wires are connected with the transparent conductive electrodes 7 while the other ends of the connecting wires are connected to a binding position of the touch chip 5; the connecting wires are made of metal or other conducting materials such as molybdenum-aluminum-molybdenum, silver paste or ITO; and the touch chip 5 is bound at the other side of the touch sensor 8, corresponding to the side at which the transparent conductive material 1 is bonded to the touch sensor 8, by the COG manufacturing process, and connected with the connecting wires by ACFs (Anisotropic Conductive Film). It should be noted that the touch chip 5 does not need package test and only needs a chip wafer. Therefore, compared with the traditional touch chip for a touch screen module, the package cost and the package test cost of the chip are reduced. Meanwhile, due to small area of the chip, the amount of space is small compared with the traditional touch chip 5 with a package outline. The FPC (Flexible Printed Circuit) is also bound on the touch sensor 8 by hot pressing. In the preferred embodiment, protective layers 6 are arranged on the transparent conductive electrodes 7. Moreover, a bonding side at which the transparent conductive material 1 is bonded to the touch sensor 8 is provided with the light shield layer 2 at an area corresponding to the area at which the touch chip 5, the flexible printed circuit 3 and the connecting wires are arranged; the touch chip 5, the flexible printed circuit 3 and the connecting wires are arranged at one side of the touch sensor 8 provided with the transparent conductive electrodes 7; and the transparent conductive material 1 is bonded to the touch sensor 8 through a bonding layer 4.

As illustrated in FIGS. 4 and 5, in a preferred embodiment of the invention, the touch chip 5, the flexible printed circuit 3 and the connecting wires are arranged on the circumference of the transparent conductive electrodes 7. Furthermore, the touch chip 5, the flexible printed circuit 3 and the connecting wires are arranged on the circumference of the transparent conductive electrodes 7 by surrounding. The light shield layer 2 is arranged at an edge of the transparent conductive material 1 and surrounds an area of the transparent conductive material 1 corresponding to the touch area of the touch sensor 8. The area is known as a light shield area X.

As illustrated in FIG. 6, the technical proposal of the invention is that: the invention provides a method for manufacturing a capacitive touch screen, wherein the capacitive touch screen comprises a transparent conductive material 1, a touch sensor 8 for touch sensing, a touch chip 5 and a flexible printed circuit 3 connected with the touch chip 5; a plurality of transparent conductive electrodes 7 forming capacitances are arranged at one side of the touch sensor 8; and the method for manufacturing the capacitive touch screen comprises the following steps of:

Step 100: formation of the electrodes and a light shield layer, wherein transparent conducting materials are coated on the touch sensor 8 to form the transparent conductive electrodes 7, and the light shield layer 2 is arranged on the transparent conductive material 1.

The specific implementation process is that: transparent conducting materials are coated on the touch sensor 8 first and then etched into the transparent conductive electrodes; after the transparent conductive electrodes are formed, conductive parts such as an ITO conductive graph in the touch sensor, wires for connecting the ITO conductive electrodes and the touch chip, and an identifier for CCD alignment are formed after coating and etching for a plurality of times; and the light shield layer 2 is coated (or printed) on a bonding side at which the transparent conductive material 1 is bonded to the touch sensor 8, corresponding to the area at which the touch chip 5, the flexible printed circuit 3 and the connecting wires are arranged.

Step 200: binding, in which the touch chip 5 is bound on the touch sensor 8.

The specific implementation process is that: the touch chip 5 is bound at the other side of the touch sensor 8, corresponding to the side at which the transparent conductive material 1 is bonded to the touch sensor 8, by the COG manufacturing process; and the flexible printed circuit 3 is bound on the touch sensor 8 by hot pressing. In a preferred embodiment, protective layers 6 are arranged on the transparent conductive electrodes 7.

Step 300: bonding, in which the transparent conductive material 1 is bonded at the other side of the touch sensor 8, corresponding to the side at which the touch sensor 8 is provided with the transparent conductive electrodes 7. The specific implementation process is that: the transparent conductive material 1 is bonded to the touch sensor 8 through a bonding layer 4.

The invention has the advantages that: the invention provides a capacitive touch screen and a manufacturing method thereof. The capacitive touch screen comprises a transparent conductive material 1, a touch sensor 8 for touch sensing and a touch chip 5, wherein a plurality of transparent conductive electrodes 7 forming capacitances are arranged at one side of the touch sensor 8; the transparent conductive material 1 is bonded at the other side of the touch sensor 8; the touch chip 5 is bound on the touch sensor 8; and the transparent conductive material 1 is provided with a light shield layer. In the capacitive touch screen and the manufacturing method thereof, the touch chip 5 does not need package test and only needs a chip wafer. Therefore, compared with the traditional touch chip for a touch screen module, the package cost and the package test cost of the chip are reduced. Meanwhile, due to small area of the chip, the amount of space is small compared with the traditional touch chip with a package outline. The invention has the advantages that: the overall material cost of the capacitive touch screen can be effectively reduced; the capacitive touch screen is easy to produce; the requirements on the manufacturing processes of the capacitive touch screen are reduced; and the product yield is improved.

The above is only further detailed description given to the invention with the attached preferred embodiments. It should not be considered that the preferred embodiments of the invention are only limited to the description. It should be understood by those skilled in the art that various simple deductions or replacements can also be made without departing from the concept of the invention and should be all within the scope of protection of the invention.

What is claimed is:

1. A capacitive touch screen, comprising a transparent conductive material, a touch sensor for touch sensing and a touch chip, wherein a plurality of transparent conductive electrodes forming capacitances arranged at one side of the touch sensor; the transparent conductive material bonded at the other side of the touch sensor; the touch chip bound on the touch sensor; and the transparent conductive material provided with a light shield layer.

2. The capacitive touch screen according to claim 1, wherein the transparent conductive electrodes are arranged in the middle of the touch sensor to form a touch area of the touch sensor; and the transparent conductive material is provided with the light shield layer at an edge of the touch area.

3. The capacitive touch screen according to claim 2, wherein the capacitive touch screen also comprises a flexible printed circuit connected with the touch chip; the flexible printed circuit is bound on the touch sensor; the transparent conductive electrodes are connected with the touch chip through connecting wires; the touch chip, the flexible printed circuit and the connecting wires are all arranged outside the touch area of the touch sensor; and the transparent conductive material is provided with the light shield layer at an area corresponding to the area at which the touch chip, the flexible printed circuit and the connecting wires are arranged.

4. The capacitive touch screen according to claim 3, wherein the touch chip is connected with the connecting wires through anisotropical conductive films.

5. The capacitive touch screen according to claim 1, wherein the touch chip is bound on the touch sensor by the COG manufacturing process.

6. The capacitive touch screen according to claim 1, wherein the flexible printed circuit is bound on the touch sensor through an anisotropical conductive film.

7. The capacitive touch screen according to claim 3, wherein the touch chip, the flexible printed circuit and the connecting wires surround the circumference of the transparent conductive electrodes.

8. The capacitive touch screen according to claim 7, wherein the light shield layer is arranged at an edge of the transparent conductive material and surrounds an area of the transparent conductive material corresponding to the touch area of the touch sensor.

9. The capacitive touch screen according to claim 1, wherein protective layers are arranged on the transparent conductive electrodes.

10. A method for manufacturing a capacitive touch screen, wherein the capacitive touch screen comprising a transparent conductive material, a touch sensor for touch sensing and a touch chip; a plurality of transparent conductive electrodes forming capacitances arranged at one side of the touch sensor; and the method for manufacturing the capacitive touch screen comprising the following steps of:
formation of the electrodes and a light shield layer, in which transparent conducting materials are coated on the touch sensor to form the transparent conductive electrodes, and the light shield layer is arranged on the transparent conductive material;
binding, in which the touch chip is bound on the touch sensor; and
bonding, in which the transparent conductive material is bonded at the other side of the touch sensor corresponding to one side of the touch sensor provided with the transparent conductive electrodes.

11. The method for manufacturing the capacitive touch screen according to claim 10, wherein in the step of the formation of the electrodes and the light shield layer, protective layers are arranged on the transparent conductive electrodes.
